(19) United States
(12) Patent Application Publication
(10) Pub. No.: US 2024/0192154 A1
(43) Pub. Date: Jun. 13, 2024

(54) PATTERN INSPECTION APPARATUS AND PATTERN INSPECTION METHOD USING THE SAME

(71) Applicant: Samsung Electronics Co., Ltd., Suwon-si (KR)

(72) Inventors: Kwangeun Kim, Suwon-si (KR); Sewon Kim, Suwon-si (KR); Huisoo Kim, Suwon-si (KR); Jeongho Ahn, Suwon-si (KR); Sungeun Lee, Suwon-si (KR)

(21) Appl. No.: 18/243,835

(22) Filed: Sep. 8, 2023

(30) Foreign Application Priority Data
Dec. 13, 2022 (KR) 10-2022-0174207
Feb. 9, 2023 (KR) 10-2023-0017259

(51) Int. Cl. G01N 23/2251

(52) U.S. Cl. CPC G01N 23/2251; G01N 2223/42; G01N 2223/6116

(57) ABSTRACT

A pattern inspection apparatus includes a sample including a plurality of holes having thicknesses that are different from each other, an electron gun configured to generate an input electron beam and emit the input electron beam onto a wafer and the sample, a stage configured to support the wafer and the sample, a detector configured to generate a scanning electron microscope (SEM) image by detecting emitted electrons from the wafer and the sample, and a processor configured to process the SEM image into a three-dimensional profiling image containing depth information of the wafer and determine whether a condition of the input electron beam has changed based on the processing of the SEM image.

### CROSS-REFERENCE TO RELATED APPLICATIONS

This application is based on and claims priority under 35 U.S.C. § 119 to Korean Patent Application No. 10-2022-0174207, filed on Dec. 13, 2022, in the Korean Intellectual Property Office, and Korean Patent Application No. 10-2023-0017259, filed on Feb. 9, 2023, in the Korean Intellectual Property Office, the disclosures of which are incorporated by reference herein in their entireties.

### BACKGROUND

The inventive concept relates to a pattern inspection apparatus and a pattern inspection method using the same, and more particularly, to a pattern inspection apparatus using a scanning electron microscope (SEM) and a pattern inspection method using the pattern inspection apparatus.

With the increasing miniaturization of semiconductor devices, the process margin in forming patterns is decreasing. In addition to the process margin for the pitch dimension of a pattern, the process margin for the etch depth of the pattern is also decreasing. Thus, in addition to a technique for measuring a two-dimensional critical dimension (CD) for measuring the pitch of a pattern, a technique for precisely measuring depth information for measuring the etch depth of a pattern has been actively developed.

For structural analysis of various types of patterns formed in semiconductor devices, a non-destructive method using an SEM is used. However, because images obtained by using an SEM are basically two-dimensional images, an undesirable destructive method is widely used to obtain depth information of a pattern.

### SUMMARY

The inventive concept provides a pattern inspection apparatus capable of measuring depth information by using a scanning electron microscope, and a pattern inspection method using the pattern inspection apparatus.

In accordance with an aspect of the disclosure, a pattern inspection apparatus includes a sample comprising a plurality of holes having thicknesses that are different from each other; an electron gun configured to generate an input electron beam and emit the input electron beam onto a wafer and the sample; a stage configured to support the wafer and the sample; a detector configured to generate a scanning electron microscope (SEM) image by detecting emitted electrons from the wafer and the sample; and a processor configured to: process the SEM image into a three-dimensional profiling image containing depth information of the wafer; and determine whether a condition of the input electron beam has changed based on the processing of the SEM image.

In accordance with an aspect of the disclosure, a pattern inspection method includes inspecting a sample with a scanning electron microscope (SEM); inspecting a wafer with the SEM; and inspecting a quality of an SEM image of the wafer, wherein the sample comprises a plurality of holes having different thicknesses that are different from each other.

In accordance with an aspect of the disclosure, a pattern inspection method includes preparing a wafer and a sample; optimizing a condition of an input electron beam incident on the wafer and the sample; inspecting the sample with a scanning electron microscope (SEM); converting an SEM image of the sample into a first gray level histogram; generating a second gray level histogram by correcting a gray level of the first gray level histogram; using the corrected gray level, inspecting the wafer with the SEM; and inspecting a quality of an SEM image of the wafer, wherein the sample comprises a plurality of holes having thicknesses that are different from each other.

In accordance with an aspect of the disclosure, a semiconductor device fabrication method includes providing at least one layer on a substrate of a wafer; performing processing on the at least one layer on the substrate of the wafer; performing the pattern inspection method of an aspect of the disclosure on the wafer; and based on a result of the pattern inspection method, forming a semiconductor device from the wafer.

### BRIEF DESCRIPTION OF THE DRAWINGS

Embodiments will be more clearly understood from the following detailed description taken in conjunction with the accompanying drawings in which:

FIG. 1 is a configuration diagram for describing a scanning electron microscope (SEM) according to an embodiment;

FIG. 2 is a block diagram illustrating a configuration of a processor according to an embodiment;

FIG. 3 is a flowchart for describing a pattern inspection method according to an embodiment;

FIG. 4 is a flowchart for describing a method of correcting the contrast of an SEM image;

FIG. 5 is a flowchart for describing a method of inspecting a wafer, according to an embodiment;

FIG. 6 is a graph showing gray level histograms according to different acceleration voltages, according to an embodiment;

FIG. 7 is a diagram illustrating a pattern of a sample according to an embodiment;

FIG. 8 is a graph showing a pre-correction gray level histogram and a post-correction gray level histogram according to an embodiment; and

FIG. 9 is a Fast Fourier Transformation (FFT) graph showing FFT intensity according to frequency, according to an embodiment.

FIG. 10 shows a semiconductor device fabrication method according to an embodiment.

### DETAILED DESCRIPTION OF THE EMBODIMENTS

Hereinafter, embodiments will be described in detail with reference to the accompanying drawings. The same reference numerals are used for the same components in the drawings, and redundant descriptions thereof will be omitted.

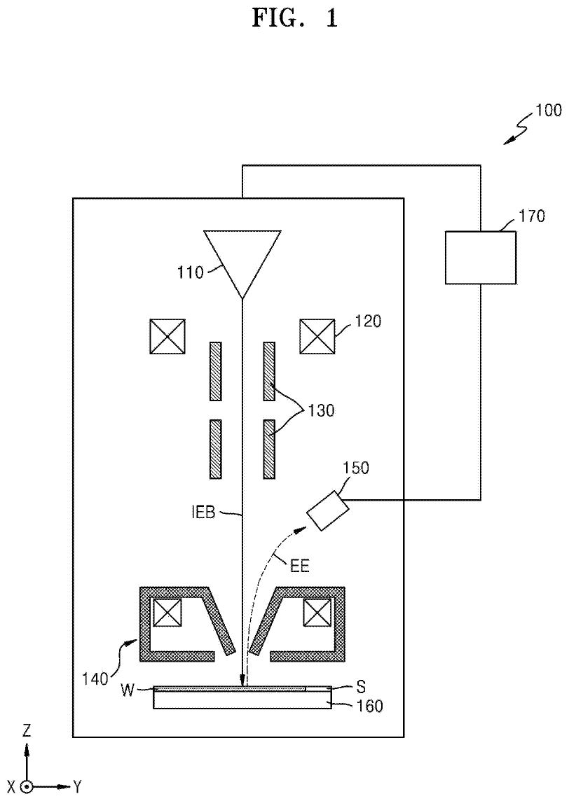

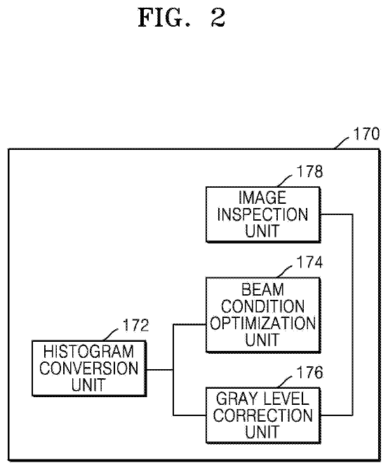

FIG. 1 is a configuration diagram for describing a scanning electron microscope (SEM) according to an embodiment. FIG. 2 is a block diagram illustrating a configuration of a processor according to an embodiment.

Referring to FIGS. 1 and 2, an SEM 100 may be configured to measure a wafer W. According to embodiments, the SEM 100 may measure, in a scanning manner, the wafer W on which a semiconductor device fabrication process has been performed. According to embodiments, the SEM 100 may measure the wafer W to obtain topographical information of the wafer W, morphological information such as the shape and size of particles constituting the wafer W, and crystallographic information such as the arrangement state of atoms in the wafer W. The SEM 100 may also be referred to as a pattern inspection apparatus 100.

According to embodiments, the SEM 100 may evaluate the semiconductor device fabrication process that has been performed on the wafer W, by emitting an input electron beam IEB to the wafer W and detecting electrons EE emitted from the wafer W by interaction between the input electron beam IEB and the wafer W. The emitted electrons EE may be generated by elastic scattering or inelastic scattering.

Elastic scattering is a phenomenon in which electrons included in the input electron beam IEB are directed in a direction opposite to the input direction of the input electron beam IEB by the potential of the atomic nuclei constituting the wafer W, without a substantial change in the energy of the electrons included in the input electron beam IEB. Electrons escaping from the surface of the wafer W by the elastic scattering are referred to as backscattered electrons, and the backscattered electrons may have an energy of about 50 eV or greater. The backscattered electrons may contain information about the structure and composition in the vicinity of the surface of the wafer W.

Inelastic scattering is a phenomenon in which, when the electrons included in the input electron beam IEB are incident on the surface of the wafer W, electrons included in atoms in the wafer W are emitted due to interactions with electrons in electron orbits of atoms in the wafer W. By the inelastic scattering, secondary electrons, Auger electrons, and/or X-rays may be emitted. The secondary electrons among the emitted electrons EE may have an energy of several eV. The secondary electrons may contain information about a concave-convex portion in the vicinity of the surface of each of the wafer W and/or a sample S.

The secondary electrons result from a process in which energy is transferred to electrons bound to the atoms in the wafer W by the electrons included in the input electron beam IEB, and thus, the electrons bound to the atoms are emitted as free electrons. When electrons at a low energy level other than the valence band are emitted as secondary electrons, X-rays may be emitted as other electrons at a higher energy level transition to the low energy level. Then, electrons are excited by the X-rays and emitted from the wafer W as Auger electrons. The X-rays may include continuum X-rays and characteristic X-rays. The Auger electrons and the X-rays may contain information about the composition and chemical bonding in the vicinity of the surface of the wafer W.

In addition, the SEM 100 may further detect signals by incoherent elastic scattering, transmitted electrons, and cathodoluminescence.

The SEM 100 may include an electron gun 110, a condenser lens 120, a deflector 130, an objective lens 140, a detector 150, a stage 160, a processor 170, and the sample S.

The electron gun 110 may generate and emit the input electron beam IEB. The wavelength of the input electron beam IEB may be determined by the energy of electrons emitted from the electron gun 110. According to embodiments, the wavelength of the input electron beam IEB may be several nm. According to embodiments, the electron gun 110 may be any one of a cold field emission (CFE) type, a Schottky emission (SE) type, and a thermionic emission (TE) type.

The electron gun 110 may generate the input electron beam IEB by applying energy higher than a work function (i.e., the difference between the energy level and the Fermi energy in a vacuum) thermally or electrically to electrons included in a solid material, which is an electron source.

The condenser lens 120 may be arranged on a path of the input electron beam IEB between the electron gun 110 and the wafer W. According to embodiments, the condenser lens 120 may focus the input electron beam IEB to the deflector 130. Accordingly, the controllability of the input electron beam IEB by the deflector 130 may be improved.

The deflector 130 may be arranged on the path of the input electron beam IEB between the condenser lens 120 and the wafer W. The deflector 130 may deflect the input electron beam IEB emitted from the electron gun 110. The deflector 130 may deflect the input electron beam IEB to pass through the condenser lens 120 and/or the objective lens 140 and then be incident on set positions on the wafer W and/or the sample S. According to embodiments, the deflector 130 may scan the input electron beam IEB on the wafer W and/or the sample S. The deflector 130 may be any one of an electric type and a magnetic type.

The objective lens 140 may be arranged on a path of the input electron beam IEB between the deflector 130 and the wafer W and/or the sample S. The objective lens 140 may focus the input electron beam IEB onto the wafer W and/or the sample S. As the input electron beam IEB is confined to a narrow region on the wafer W and/or the sample S, the resolution of the SEM 100 may be further improved.

A system for delivering the input electron beam IEB including the condenser lens 120, the deflector 130, and the objective lens 140 is described above, but this is a non-limiting example and does not limit the technical spirit of the inventive concept in any sense. One of skill in the art may easily realize a system for delivering the input electron beam IEB including additional condenser lenses and/or additional deflectors, based on the description provided herein.

The detector 150 may detect at least some of the emitted electrons EE reflected from the wafer W and/or the sample S. For example, the detector 150 may detect secondary electrons and/or backscattered particles emitted from the wafer W and/or the sample S. In addition, the detector 150 may obtain an SEM image by detecting the emitted electrons EE.

The stage 160 may support the wafer W and the sample S to be measured. The stage 160 may move the wafer W and/or the sample S in horizontal and vertical directions, or rotate the wafer W and/or the sample S about an axis oriented in the vertical direction (Z direction), such that the wafer W and/or the sample S are aligned with respect to an optical system (i.e., an optical system consisting of the electron gun 110, the condenser lens 120, the deflector 130, and the objective lens 140) for delivering the input electron beam IEB. For example, the sample S may be arranged on one side of the wafer W on the stage 160. The sample S may be attached to the stage 160 and may be present independently of any individual wafer W.

In the present specification, a direction parallel to the upper surface of the stage 160 is defined as the horizontal direction (X direction and/or Y direction), and a direction perpendicular to the horizontal direction (X direction and/or Y direction) is defined as the vertical direction (Z direction).

The processor 170 may process one or more SEM images generated by the detector 150. The processor 170 may also be referred to as an image processing unit. The processor 170 may process an SEM image into a three-dimensional profiling image including depth information of the wafer W. In addition, the processor 170 may correct image contrast of the SEM image. The processor 170 may include a histogram converter 172, a beam condition optimization unit 174, a gray level correction unit 176, and an image inspection unit 178.

Each unit described herein may include a separate computer, or some or all of the unit may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The units of the processor 170 (e.g., the histogram converter 172, the beam condition optimization unit 174, the gray level correction unit 176, and the image inspection unit 178) may each correspond to a separate segment or segments of software (e.g., a subroutine) which configure the processor 170, and/or may correspond to segment(s) of software that also correspond to one or more other units described herein (e.g., the units may share certain segment(s) of software or be embodied by the same segment(s) of software). As is understood, “software” refers to prescribed rules to operate a computer, such as code or script.

The histogram converter 172 may derive a gray level histogram based on an SEM image obtained by the detector 150. That is, the histogram converter 172 may perform conversion of an SEM image into a gray level histogram.

The gray level histogram represents the distribution of contrast values for one or more pixels included in the SEM image. For example, with 256 gray levels, black corresponds to 0, white corresponds to 255, and gray is expressed as 1 to 254 according to the degree of contrast between white and black. A 256-gray level histogram obtained by converting the SEM image represents a graph obtained by examining the frequency of each contrast value. However, the number of gray levels is not limited to 256.

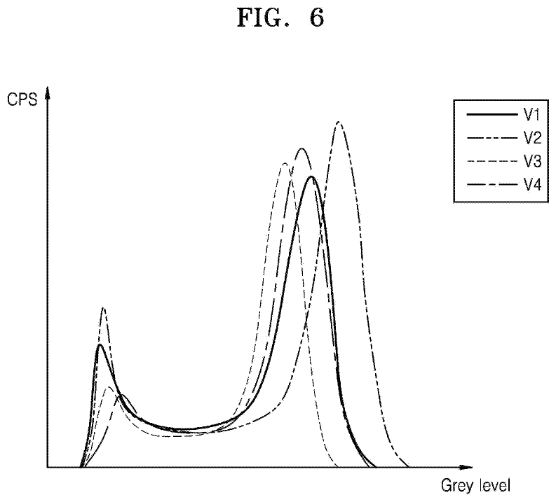

The beam condition optimization unit 174 may derive the optimum condition of the input electron beam IEB based on the gray level histogram generated by the histogram converter 172. A process, performed by the beam condition optimization unit 174, of deriving the optimum condition of the input electron beam IEB is described in detail below with reference to FIG. 6.

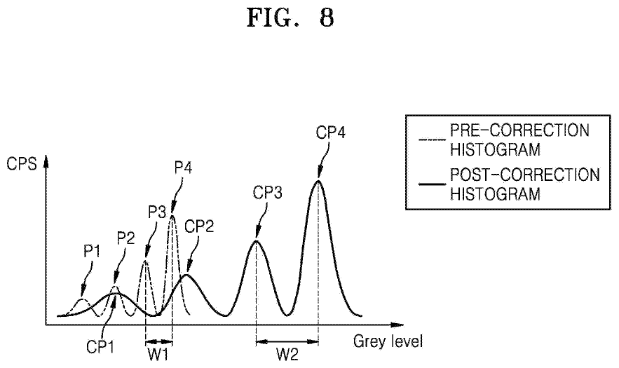

The gray level correction unit 176 may correct the gray levels of the gray level histogram generated by the histogram converter 172. The gray level correction unit 176 may improve the sharpness of the SEM image by correcting the gray levels. A process, performed by the gray level correction unit 176, of correcting the gray levels is described in detail below with reference to FIG. 8.

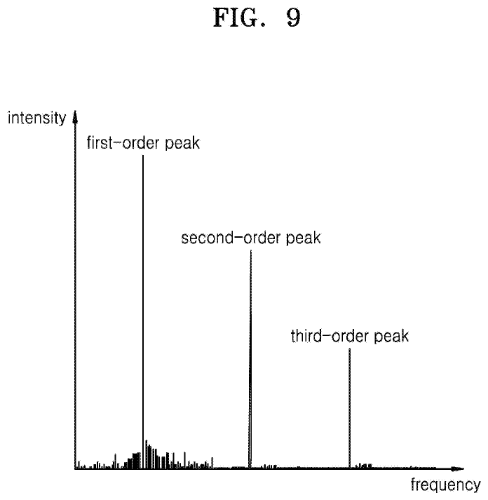

The image inspection unit 178 may determine whether the state of the input electron beam IEB has changed, based on the SEM image obtained by the detector 150. When the image inspection unit 178 determines that the state of the input electron beam IEB has changed, the image inspection unit 178 may control the gray level correction unit 176 to change the input electron beam IEB to be in the optimum condition and/or to correct the gray levels of the gray level histogram. A process, performed by the image inspection unit 178, of determining whether the state of the input electron beam IEB has changed is described in detail below with reference to FIG. 9.

The role of each of the histogram converter 172, the beam condition optimization unit 174, the gray level correction unit 176, and the image inspection unit 178 illustrated in FIG. 2 is an example and may be variously modified. In addition, the roles of the histogram converter 172, the beam condition optimization unit 174, the gray level correction unit 176, and the image inspection unit 178 may be combined with each other or divided.

According to an embodiment, the SEM 100 may further include a controller configured to control each component and optical elements included in the SEM 100. For example, the controller may be configured to generate signals for controlling the oscillation of the electron gun 110, the operation of the condenser lens 120, the operation of the deflector 130, and the operation of the objective lens 140.

The controller and the processor 170 may be computing devices such as a workstation computer, a desktop computer, a laptop computer, or a tablet computer. The controller and the processor 170 may be configured as separate hardware units, or may be separate software units included in one hardware unit. The controller and the processor 170 may be simple controllers, a complex processor such as a microprocessor, a central processing unit (CPU), or a graphics processing unit (GPU), a processor configured by software, or dedicated hardware or firmware. The controller and the processor 170 may be implemented by, for example, a general-purpose computer, a digital signal processor (DSP), a field-programmable gate array (FPGA), and application-specific hardware such as an application-specific integrated circuit (ASIC).

According to some embodiments, operations of the controller and the processor 170 may be implemented as commands stored in a machine-readable medium that is readable and executable by one or more processors. Here, the machine-readable medium may include any mechanism for storing and/or transmitting information in a form readable by a machine (e.g., a computing device). For example, the machine-readable medium may include read-only memory (ROM), random-access memory (RAM), a magnetic disk storage medium, an optical storage medium, flash memory devices, electrical, optical, acoustical, or other radio wave signals (e.g., carrier waves, infrared signals, digital signals, etc.), and other arbitrary signals.

The controller and the processor 170 may also include firmware, software, routines, and instructions for performing the operations of the controller and the processor 170 described above or any process to be described below. However, this is for convenience of description, and it should be understood that the operations of the controller and the processor 170 may be carried out by a computing device, a processor, a controller, or other devices that execute firmware, software, routines, instructions, etc.

A general pattern inspection apparatus does not include a sample including depth information and cannot thus measure depth information about a pattern of a wafer. That is, a general pattern inspection apparatus is able to measure only the two-dimensional CD of a wafer.

On the contrary, the pattern inspection apparatus 100 of the inventive concept is able to measure depth information about the pattern of the wafer W by using depth information of the sample S including depth information as a barometer (e.g., as a calibration mechanism). That is, the pattern inspection apparatus 100 of the inventive concept is able to perform a three-dimensional profiling inspection on the wafer W.

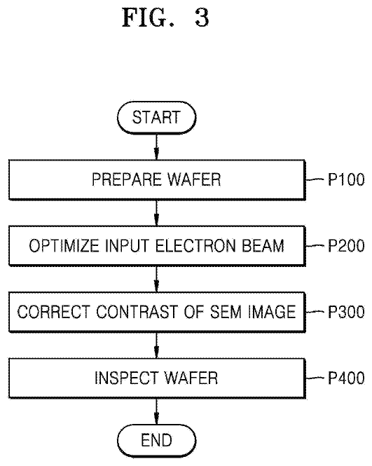

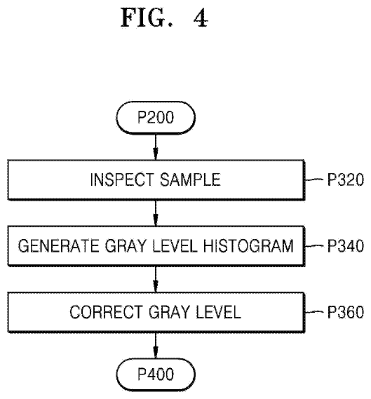

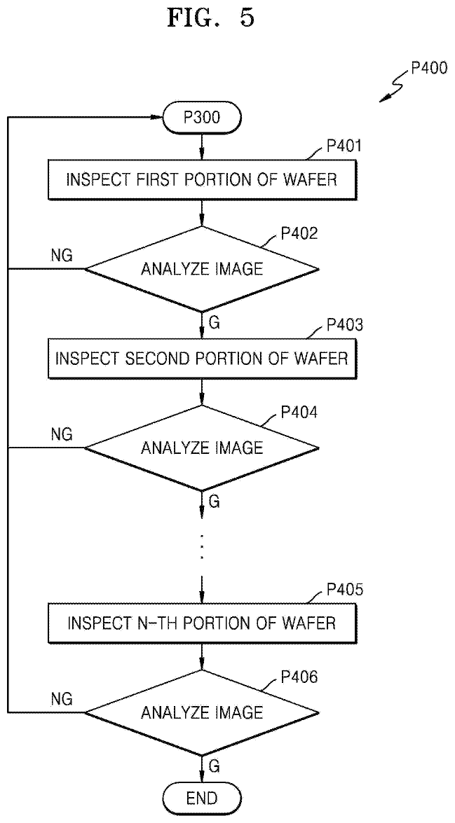

FIG. 3 is a flowchart for describing a pattern inspection method according to an embodiment, FIG. 4 is a flowchart for describing a method of correcting the contrast of an SEM image, and FIG. 5 is a flowchart for describing a method of inspecting a wafer, according to an embodiment. Hereinafter, descriptions are provided with reference to FIGS. 1 and 2.

Referring to FIGS. 3 to 5, the wafer W and the sample S may be provided on the stage 160 of the pattern inspection apparatus 100 (P100). Each of the wafer W and the sample S may include a trench, a groove, and/or a hole. Accordingly, each of the wafer W and the sample S may include a concave-convex portion having a step in the vertical direction (Z direction).

For example, the trench, the groove, and/or the hole formed in the wafer W may be formed by semiconductor fabrication processes for fabricating a semiconductor device such as dynamic RAM (DRAM) and vertical NAND (VNAND). For example, an interlayer insulating film covering staircase-shaped conductive patterns may be formed on the wafer W, and a plurality of contact holes having different vertical thicknesses and exposing each of the conductive patterns may be formed by etching the interlayer insulating film. That is, the plurality of contact holes may be formed in the interlayer insulating film.

Thereafter, the input electron beam IEB may be optimized (P200). When the energy of the input electron beam IEB increases, the yield of backscattered electrons may increase, but the resolution of the SEM image may decrease. On the contrary, when the energy of the input electron beam IEB decreases, the resolution of the SEM image may increase, but the yield of backscattered electrons may decrease, and thus, the quality of the SEM image may decrease. Through histogram analysis of the SEM image, the input electron beam IEB may be optimized. That is, the input electron beam IEB may be optimized based on the yield of the backscattered electrons and the resolution of the SEM image.

Hereinafter, a process of optimizing the input electron beam IEB is described in detail with reference to FIG. 6.

FIG. 6 is a graph showing gray level histograms according to different acceleration voltages, according to an embodiment. The horizontal axis represents gray level and the vertical axis represents frequency (counts per second (CPS)). The horizontal axis and the vertical axis are expressed in arbitrary units (a.u.).

Referring to FIG. 6, the histogram converter 172 may cause the electron gun 110 to emit the input electron beam IEB into the holes (or trenches) of the wafer W and/or the sample S at different acceleration voltages and convert obtained SEM images into gray level histograms. The gray level histogram for each acceleration voltage may have two peaks. That is, the histogram according to each acceleration voltage may include two peak values. The peak refers to a point having the maximum frequency in a gray level histogram. In addition, the peak value may be any one of a gray level value and a frequency value at the peak.

Among the two peaks, the peak with a lower gray level and/or frequency may be referred to as a bottom peak, and the peak with a higher gray level and/or frequency may be referred to as a top peak. The bottom peak may have information of a CD of the bottom surface of the hole, and the top peak may have information of a CD in the vicinity of the top surface of the hole. In order to collect data about the bottom surface of the hole, the beam condition optimization unit 174 may derive the optimum condition of the input electron beam IEB based on data of the bottom peak. For example, from the gray level histogram for each acceleration voltage, the beam condition optimization unit 174 may derive the optimum condition (e.g., the optimum acceleration voltage) of the input electron beam IEB based on the bottom peak value and the width of the bottom peak.

For example, the controller may control the electron gun 110 to accelerate the input electron beam IEB at first to fourth voltages V1, V2, V3, and V4. The input electron beam IEB accelerated at the first to fourth voltages V1, V2, V3, and V4 may be emitted into the hole. In FIG. 6, the bottom peak value and the width of the bottom peak at the second voltage V2 are greater than those at the first, third, and fourth voltages V1, V3, and V4, respectively, and thus, the beam condition optimization unit 174 may select the second voltage V2 as an optimum input electron beam IEB.

Although FIG. 6 shows as an example the gray level histograms obtained at four different acceleration voltages, the optimum condition of the input electron beam IEB may be derived based on gray level histograms obtained at fewer than four or more than four different acceleration voltages.

Thereafter, the pattern inspection apparatus 100 may correct the contrast of the SEM image (P300 of FIG. 3). FIG. 4 shows in more detail the method P300 of correcting the contrast of the SEM image. First, the pattern inspection apparatus 100 may scan the sample S (P320 of FIG. 4). The pattern inspection apparatus 100 may scan the surface of the sample S. Depth information of the pattern of the wafer W may be measured by comparison with the gray level histogram of the sample S.

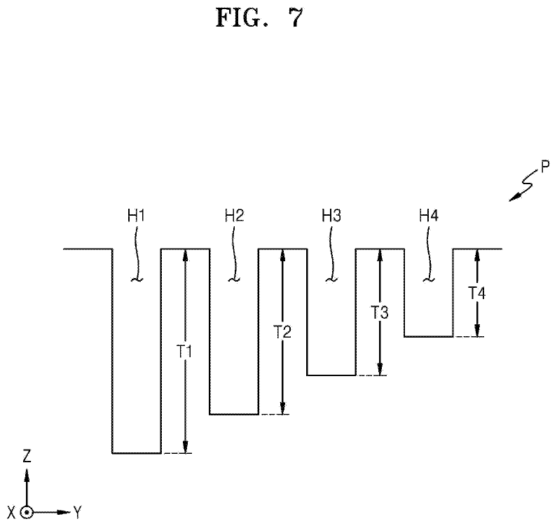

Hereinafter, the sample S is described in detail with reference to FIG. 7.

FIG. 7 is a diagram illustrating a pattern of a sample according to an embodiment.

Referring to FIG. 7, the sample S may include a pattern P. The pattern P may be a concave-convex pattern P having different thicknesses. For example, the pattern P may include a plurality of holes spaced apart from each other in the horizontal direction (X direction and/or Y direction), at least two holes of which have different thicknesses (e.g., different depths). The planar shape of each of the plurality of holes may be any one of a circular shape, an elliptical shape, and a polygonal shape.

The pattern inspection apparatus 100 may inspect the sample S by using the pattern P with different thicknesses and inspect a pattern formed on the wafer W based on data about the sample S. That is, the sample S may serve as a barometer (e.g., a calibration mechanism) that provides information about the thickness of the pattern of the wafer W.

Although FIG. 7 illustrates as an example that the pattern P has first to fourth holes H1, H2, H3, and H4, the pattern P may have a plurality of holes with three or fewer different thicknesses and/or may include a plurality of holes with five or more different thicknesses.

The first hole H1 may have a first thickness T1 and extend in the vertical direction (Z direction), the second hole H2 may have a second thickness T2 and extend in the vertical direction (Z direction), the third hole H3 may have a third thickness T3 and extend in the vertical direction (Z direction), and the fourth hole H4 may have a fourth thickness T4 and extend in the vertical direction (Z direction). The first thickness T1 may be greater than the second to fourth thicknesses T2, T3, and T4, the second thickness T2 may be greater than the third and fourth thicknesses T3 and T4, and the third thickness T3 may be greater than the fourth thickness T4. Each of the first to fourth thicknesses T1, T2, T3, and T4 may range from about 10 nm to about 1 μm.

Thereafter, the pattern inspection apparatus 100 may generate a gray level histogram for the pattern P of the sample S (P340). For example, the histogram converter 172 may generate the gray level histogram for the pattern P of the sample S based on the SEM image. The gray level histogram for the pattern P of the sample S generated by the histogram converter 172 may be referred to as a pre-correction gray level histogram.

Hereinafter, a process of correcting gray levels of a gray level histogram is described in detail with reference to FIG. 8.

FIG. 8 is a graph showing a pre-correction gray level histogram and a post-correction gray level histogram according to an embodiment. In FIG. 8, the dashed-line graph represents the pre-correction gray level histogram and the solid line graph represents the post-correction gray level histogram. The horizontal axis represents gray level and the vertical axis represents frequency (CPS). The horizontal axis and the vertical axis are expressed in arbitrary units (a.u.).

Referring to FIG. 8, the pre-correction gray level histogram may have first to fourth peaks P1, P2, P3, and P4.

Thereafter, the pattern inspection apparatus 100 may correct gray levels of the gray level histogram (P360). For example, the gray level correction unit 176 may generate a gray level histogram having first to fourth corrected peaks CP1, CP2, CP3, and CP4.

For example, the first to fourth corrected peaks CP1, CP2, CP3, and CP4 may be greater than the first to fourth peaks P1, P2, P3, and P4, respectively. That is, the peak gray level and/or CPS values of the post-correction gray level histogram may be greater than the peak gray level and/or CPS values of the pre-correction gray level histogram, respectively.

In addition, widths by which the first to fourth corrected peaks CP1, CP2, CP3, and CP4 are spaced apart from each other may be greater than widths by which the first to fourth peaks P1, P2, P3, and P4 are spaced apart from each other. For example, a second width W2 between the third corrected peak CP3 and the fourth corrected peak CP4 is greater than a first width W1 between the third peak P3 and the fourth peak P4. That is, the width between adjacent peaks in the post-correction gray level histogram may be greater than the width between adjacent peaks in the pre-correction gray level histogram.

Accordingly, the contrast of a corrected SEM image corresponding to the post-correction gray level histogram may be greater than the contrast of an uncorrected SEM image corresponding to the pre-correction gray level histogram. That is, the corrected SEM image may be clearer than the uncorrected SEM image. Thus, the corrected SEM image may be easily analyzed.

The gray level correction unit 176 may correct the gray level histogram based on the respective values of the first to fourth corrected peaks CP1, CP2, CP3, and CP4. The gray level correction unit 176 may correct the gray level histogram based on gradient information of lines defined by the first to fourth corrected peaks CP1, CP2, CP3, and CP4. The gradient information of the line defined by each peak may be information related to the contrast of the SEM image. The uncorrected gray level histogram may be stored for later use in the wafer inspection process to be described below. For example, a contrast stretching method may be used for correcting the gray level histogram. The constrast stretching method expands the range of pixel intensities of the gray level histogram,

Thereafter, the pattern inspection apparatus 100 may inspect the wafer W (P400 of FIG. 3). FIG. 5 shows in more detail the method P400 of inspecting the wafer W. For example, the pattern inspection apparatus 100 may divide the wafer W into a plurality of pixels and then inspect each of the plurality of pixels. For example, the plurality of pixels may be divided into first to N-th pixels (N is a natural number). First, the pattern inspection apparatus 100 may inspect a first portion of the wafer W (P401 of FIG. 5). For example, the first portion of the wafer W may be the first pixel of the wafer and the pattern inspection apparatus 100 may inspect the first pixel of the wafer W. Thereafter, the image inspection unit 178 may analyze an SEM image obtained from the first portion of the wafer W to determine whether the optimum condition of the input electron beam IEB is maintained (P402).

Hereinafter, a process of determining whether the optimum condition of the input electron beam IEB is maintained is described in detail with reference to FIG. 9.

FIG. 9 is a Fast Fourier Transformation (FFT) graph showing FFT intensity according to frequency, according to an embodiment. The horizontal axis represents frequency and the vertical axis represents FFT intensity. The horizontal axis and the vertical axis are expressed in arbitrary units (a.u.).

The image inspection unit 178 may generate an FFT graph by performing FFT on the SEM image obtained by inspecting the first pixel of the wafer W. FFT may anlayze periodic features and repetitive features in the SEM image. That is, the FFT graph may include information of the SEM image in the form of a frequency domain.

The FFT graph may include a plurality of peaks. The plurality of peaks may correspond to a first-order peak, a second-order peak, a third-order peak, and the like, respectively, based on relative intensity.

Here, the first-order peak may include information related to the overall shape of an SEM image pattern and the second-order or higher-order peaks may include information related to the sharpness of one or more edges of the SEM image pattern. The second-order or higher-order peaks may be referred to as high-order peaks.

The image inspection unit 178 may inspect the quality of the SEM image based on the peak value and peak width of each high-order peak. When the peak value and peak width of each measured high-order peak have an error within a set range for a threshold, the image inspection unit 178 may determine that the measured SEM image is good (G). On the contrary, when the peak value and peak width of each measured high-order peak have an error outside the set range for the threshold, the image inspection unit 178 may determine that the measured SEM image is poor (NG).

When it is determined that the measured image is good, it may be determined that the input electron beam IEB is maintained in the optimum state, and when it is determined that the measured image is poor, it may be determined that the input electron beam IEB is not in the optimum state.

When the SEM image obtained from the first portion is good (G), the pattern inspection apparatus 100 may inspect a second portion of the wafer W, which is a subsequent process (P403). For example, the pattern inspection apparatus 100 may inspect the second pixel of the wafer W. Thereafter, the image inspection unit 178 may analyze an SEM image obtained from the second portion of the wafer W to determine whether the optimum condition of the input electron beam IEB is maintained (P404). When the SEM image of the second portion is poor, the pattern inspection apparatus 100 may correct the contrast of the image (P300). That is, when the SEM image obtained from the second portion is poor (NG), the pattern inspection apparatus 100 may correct the input electron beam IEB.

When the SEM image obtained from the second portion is poor (NG), the process for correcting the contrast of the SEM image (P300) may be performed again. The pattern inspection apparatus 100 may adjust electron beam and contrast values according to a result of a comparison between the initial uncorrected gray level histogram and the newly obtained gray level histogram. Then, the pattern inspection apparatus 100 may inspect the second portion of the wafer W again using the adjusted electron beam and contrast values.

The pattern inspection apparatus 100 may inspect an N-th portion of the wafer W after repeating, N−1 times, the processes of pixel-by-pixel inspection of the wafer W and SEM image analysis (P405). For example, the pattern inspection apparatus 100 may inspect an N-th pixel of the wafer W. Thereafter, the image inspection unit 178 may analyze an SEM image obtained from the N-th portion of the wafer W to determine whether the optimum condition of the input electron beam IEB is maintained (P406). When the SEM image obtained from the N-th portion is good (G), the pattern inspection method may be terminated. When the SEM image obtained from the N-th portion is poor (NG), the pattern inspection apparatus 100 may correct the input electron beam IEB.

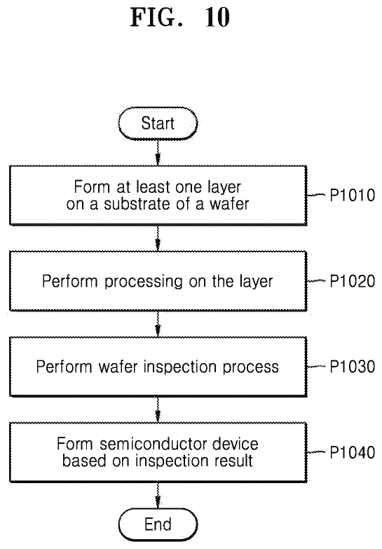

With reference to FIG. 10, in accordance with an aspect of the inventive concept, a method of fabricating a wafer may be provided. The method may include forming at least one layer on a substrate of a wafer (P1010). Processing may then be performed on the layer such as an etching process or a patterning process (P1020). A wafer inspection process according to one or more embodiments of the present inventive concept may be performed on the processed wafer (P1030). Based on a determination, as a result of the inspection process, that one or more portions of the wafer are good (G), the method may include forming a semiconductor device from the processed wafer (P1040).

Because a general pattern inspection method does not include a process of measuring a sample, the reliability of depth information of an SEM is relatively low and the precision of the depth information of the SEM image is relatively low.

On the contrary, the pattern inspection method according to aspects of the inventive concept includes a process of measuring the sample S, and thus, the reliability of depth information of an SEM image is relatively high and the precision of the depth information of the SEM image is relatively high.

In addition, the pattern inspection method according to aspects of the inventive concept includes optimizing the condition of the input electron beam IEB, such that the precision of the SEM image may be high. In addition, the pattern inspection method according to aspects of the inventive concept includes inspecting the quality of the SEM image in real time whenever a pixel of the wafer W is inspected, such that the input electron beam IEB may be maintained in an optimum state. Therefore, the precision of the SEM image may be high.

Embodiments have been described herein and illustrated in the drawings. Although the embodiments have been described herein by using specific terms, they are used only for the purpose of explaining the technical spirit of the inventive concept and not used to limit the meaning or scope of the claims. Therefore, those of skill in the art will understand that various modifications and other equivalent embodiments may be derived from the embodiments described herein. Therefore, the true technical scope of protection of the inventive concept should be determined by the appended claims.

While the inventive concept has been particularly shown and described with reference to embodiments thereof, it will be understood that various changes in form and details may be made therein without departing from the spirit and scope of the following claims.

1. A pattern inspection apparatus comprising:
a sample comprising a plurality of holes having thicknesses that are different from each other;
an electron gun configured to generate an input electron beam and emit the input electron beam onto a wafer and the sample;
a stage configured to support the wafer and the sample;
a detector configured to generate a scanning electron microscope (SEM) image by detecting emitted electrons from the wafer and the sample; and
a processor configured to:
process the SEM image into a three-dimensional profiling image containing depth information of the wafer; and
determine whether a condition of the input electron beam has changed based on the processing of the SEM image.

2. The pattern inspection apparatus of claim 1, wherein the thicknesses of the plurality of holes are between about 10 nm and about 1 μm.

3. The pattern inspection apparatus of claim 1, wherein the processor comprises:
a histogram converter configured to convert the SEM image into a gray level histogram; and
a gray level correction unit configured to correct a gray level of the gray level histogram based on a gradient value of a line defined by a peak of the gray level histogram.

4. The pattern inspection apparatus of claim 1, wherein the processor comprises a beam condition optimization unit configured to:
optimize the condition of the input electron beam, and
select a condition of the input electron beam based on a yield of backscattered electrons and a resolution of the SEM image.

5. The pattern inspection apparatus of claim 1, wherein the processor comprises an image inspection unit configured to inspect a quality of the SEM image by performing fast Fourier transformation (FFT) on the SEM image.

6. The pattern inspection apparatus of claim 5, wherein the image inspection unit is further configured to inspect the SEM image based on a peak value and a peak width of each high-order peak of an FFT graph.

7. A pattern inspection method comprising:
inspecting a sample with a scanning electron microscope (SEM);
inspecting a wafer with the SEM; and
inspecting a quality of an SEM image of the wafer,
wherein the sample comprises a plurality of holes having thicknesses that are different from each other.

8. The pattern inspection method of claim 7, wherein the plurality of holes comprises:
one or more first holes having a first thickness;
one or more second holes having a second thickness, wherein the second thickness is less than the first thickness;
one or more third holes having a third thickness, wherein the third thickness is less than the second thickness; and
one or more fourth holes having a fourth thickness, and
the fourth thickness is less than the third thickness.

9. The pattern inspection method of claim 7, wherein the plurality of holes are spaced apart from each other in a horizontal direction.

10. The pattern inspection method of claim 7, wherein the inspecting of the sample with the SEM comprises:
converting the SEM image of the sample into a gray level histogram; and
correcting a gray level of the gray level histogram.

11. The pattern inspection method of claim 10, wherein the correcting of the gray level of the gray level histogram is performed based on a gradient value of a line defined by a peak of the gray level histogram.

12. The pattern inspection method of claim 10, wherein, after the correcting of the gray level of the gray level histogram, peak values of the gray level histogram are greater than respective peak values of the gray level histogram before the correcting of the gray level of the gray level histogram.

13. The pattern inspection method of claim 10, wherein, after the correcting of the gray level of the gray level histogram, a width between adjacent peaks in the gray level histogram is greater than a width between adjacent peaks in the gray level histogram before the correcting of the gray level of the gray level histogram.

14. A pattern inspection method comprising:
preparing a wafer and a sample;
optimizing a condition of an input electron beam incident on the wafer and the sample;
inspecting the sample with a scanning electron microscope (SEM);
converting an SEM image of the sample into a first gray level histogram;
generating a second gray level histogram by correcting a gray level of the first gray level histogram;
using the corrected gray level, inspecting the wafer with the SEM; and
inspecting a quality of an SEM image of the wafer,
wherein the sample comprises a plurality of holes having thicknesses that are different from each other.

15. The pattern inspection method of claim 14, wherein the optimizing of the condition of the input electron beam comprises:
causing the input electron beam having different acceleration voltages to be incident on the wafer;
generating the SEM image of the wafer; and
converting the SEM image of the wafer into a third gray level histogram.

16. The pattern inspection method of claim 15, wherein the third gray level histogram includes a plurality of peaks,
wherein the optimizing of the condition of the input electron beam comprises selecting the input electron beam in which a peak value of a bottom peak is high or the width of the bottom peak is high, and
wherein the bottom peak is a peak from among the plurality of peaks having a lower gray level or a lower frequency.

17. The pattern inspection method of claim 14, wherein the inspecting of the quality of the SEM image of the wafer comprises performing fast Fourier transformation (FFT) on the SEM image of the wafer.

18. The pattern inspection method of claim 17, wherein the inspecting of the quality of the SEM image of the wafer is performed based on an intensity or a width of each second-order or higher-order peak of an FFT graph generated by the performing of the FFT on the SEM image of the wafer.

19. The pattern inspection method of claim 14, wherein the wafer comprises a plurality of pixels, and
the inspecting of the quality of the SEM image of the wafer is performed on each of the plurality of pixels.

20. The pattern inspection method of claim 14, wherein peak values and a width between adjacent peaks of the second gray level histogram are greater than respective peak values and a width between adjacent peaks of the first gray level histogram.

21. (canceled)
